(19) United States
(12) Patent Application Publication
(10) Pub. No.: US 2024/0258637 A1
(43) Pub. Date: Aug. 1, 2024

(54) Battery Pack Device, Battery Pack, and Method for Manufacturing a Battery Pack Device

(71) Applicant: Robert Bosch GmbH, Stuttgart (DE)

(72) Inventors: Florian Kneer, Duernau (DE); Marcin Rejman, Waiblingen (DE)

(21) Appl. No.: 18/416,616

(22) Filed: Jan. 18, 2024

(30) Foreign Application Priority Data
Jan. 30, 2023 (DE) 10 2023 200 712.6

(51) Int. Cl. H01M 50/296; H01M 50/238; H01M 50/247

(52) U.S. Cl. CPC H01M 50/296; H01M 50/238; H01M 50/247; H01M 2220/30

(57) ABSTRACT

A battery pack device includes (i) at least one battery pack housing, and (ii) at least one interface for an electrical and mechanical connection to a consumer which is arranged on an interface side of the battery pack housing. The interface includes at least one contact support which is arranged adjacent to a wall of the battery pack device. The wall is designed to be curved.

This application claims priority under 35 U.S.C. § 119 to patent application no. DE 10 2023 200 712.6, filed on Jan. 30, 2023 in Germany, the disclosure of which is incorporated herein by reference in its entirety.

### BACKGROUND

Previously proposed is a battery pack device comprising at least one battery pack housing and comprising at least one interface for an electrical and mechanical connection to a consumer, which is arranged on an interface side of the battery pack housing, the interface having at least one contact support arranged adjacent to a wall.

### SUMMARY

The disclosure is based on a battery pack device comprising at least one battery pack housing and comprising at least one interface for an electrical and mechanical connection to a consumer, which is arranged on an interface side of the battery pack housing, the interface having at least one contact support which is arranged adjacent to a wall of the battery pack device.

It is proposed that the wall is designed to be curved.

A particularly high level of robustness can be achieved by designing the battery pack device in this way. A particularly durable and stable battery pack device can be provided. A particularly high level of safety can be achieved. Advantageously, a particularly high product quality can be achieved. Such a design of the battery pack device makes it possible to reduce voltage peaks and/or improve the flow of force. Advantageously, tearing of the battery pack device and/or the interface caused by voltage peaks can be counteracted particularly easily and/or effectively.

In particular, the interface is designed to be at least partially integral with the battery pack housing. The expression “at least one unit or one object and at least one further unit or object are at least partially designed to be integral with one another”, is in particular understood to mean that at least one element of the unit or of the object is designed to be integral with at least one further element of the further unit or with the further object. The term “integral” is understood to mean connected in at least a bonded manner, e.g. by a welding process, a soldering process, an adhesive bonding process, a molding process, and/or another process that appears advantageous to the skilled person, and/or advantageously designed to be integral, e.g. by production from a casting and/or by production in a single- or multi-component injection molding method and advantageously from a single blank.

The battery pack device is preferably part of a battery pack, in particular a hand-held power tool rechargeable battery pack. The contact support comprises, e.g., an electrical contact element or a plurality of electrical contact elements. The battery pack, in particular the battery pack device, preferably comprises a battery cell unit. The battery cell unit preferably comprises a battery cell or a plurality of battery cells, in particular interconnected battery cells. The at least one electrical contact element can be designed in particular as a contact plug or as a contact blade.

The at least one electrical contact element is in particular provided to establish an electrical connection between the battery cell unit and the consumer, in particular a battery pack interface of the consumer. The term “provided” is understood to mean specifically configured, specifically designed and/or specifically equipped. An object being provided for a particular function is understood to mean that the object fulfills and/or performs that particular function in at least one application and/or operating state.

The consumer is preferably designed as a hand-held power tool, e.g. as a drilling machine, as a screwing machine, as a sawing machine, as a grinding machine, or as another hand-held power tool that appears advantageous to a skilled person. It is alternatively conceivable that the consumer is designed as a household appliance, e.g. as a kitchen appliance, as a cleaning appliance, in particular as a vacuum cleaner, as a radio, as a light, or as another electrical appliance that appears advantageous to a skilled person.

In particular, the interface comprises a mechanical connection unit for a mechanical connection of the battery pack, in particular the battery pack device, to the consumer. Preferably, the battery pack device can be attached to the consumer by means of the mechanical connection unit, preferably detachably, particularly preferably non-destructively detachably. In particular, the mechanical connection unit comprises at least one guide rail, preferably two guide rails. Preferably, the consumer can be guided along the guide rail for mounting and/or dismounting the consumer on/from the battery pack, in particular the battery pack device. The guide rail is provided in particular as a holding rail for the consumer.

In particular, the interface side faces the consumer when the battery pack, preferably the battery pack device, is arranged on the consumer. The wall is preferably designed to be integral with at least one part of the battery pack housing and/or at least one part of the interface. In particular, the wall is arranged between the interface, especially the contact support, and the battery pack housing. Preferably, the wall connects the battery pack housing to the interface, in particular to the contact support, in particular at least in a partial area of the battery pack device.

In particular, the interface comprises an interface housing. The interface housing is designed to be at least partially integral with the battery pack housing and/or the wall. In particular, the wall adjoins an outer surface of the interface, preferably the interface housing. In particular, the wall is connected to an outer surface of the battery pack housing. The outer surface of the battery pack housing preferably extends at an angle to the outer surface of the interface housing. The term “angular” is in particular understood to mean an angle greater than 0° and less than 180°. Preferably, the outer surface of the battery pack housing is at least substantially perpendicular to the outer surface of the interface, in particular the interface housing. The term “substantially perpendicular” is understood to mean an orientation of a direction relative to a reference direction, whereby the direction and the reference direction, in particular as viewed in a projection plane, enclose an angle of 90° and the angle features a maximum deviation of in particular less than 8°, advantageously less than 5° and particularly advantageously less than 2°.

The wall preferably features a constant curvature. It is alternatively conceivable that the wall features a varying curvature. The wall preferably defines a circular arc with a center angle of between 0° and 180°, preferably 90°.

It is further proposed that the battery pack housing comprises a first surface on the interface side and a second surface that is recessed relative to the first surface, whereby the wall is arranged at least partially in an area of the second surface. A particularly compact battery pack device can be provided in an advantageous manner. A particularly robust battery pack device can be achieved without an increased space requirement. The expression “at least partially” is understood to mean at least 10%, preferably at least 25% and particularly preferably at least 40% of a total volume and/or a total mass of an object, in particular the wall. The wall is preferably arranged at least substantially completely in the area of the second surface, at least when viewed in a direction perpendicular to the second surface. The expression “at least substantially complete” is understood to mean at least 50%, preferably at least 75% and particularly preferably at least 90% of a total volume and/or a total mass of an object, in particular the wall. In particular, the wall is arranged on the second surface. The first surface is preferably arranged on the interface side. The second surface is preferably arranged on the interface side. The first surface preferably extends at least substantially parallel to the second surface. In this context, the term “substantially parallel” is in particular understood to mean an orientation of a direction relative to a reference direction, in particular in a plane, whereby the direction features a deviation from the reference direction of in particular less than 8°, advantageously less than 5°, and particularly advantageously less than 2°. Alternatively, however, it is also conceivable that the first surface extends at an angle to the second surface. A value of a maximum height of the wall preferably corresponds to a value of a minimum distance of the first surface from the second surface, in particular at least when viewed in a direction perpendicular to the first surface and/or second surface. It is alternatively conceivable that a value of the maximum height of the wall is smaller or greater than a value of the minimum distance between the first surface and the second surface, in particular at least when viewed in the direction perpendicular to the first surface and/or second surface. The second surface is recessed in relation to the first surface, particularly with regard to the interface. In particular, the first surface and the second surface each define a plane, with the wall preferably being arranged at least partially, preferably at least substantially completely and particularly preferably completely between the planes. The second surface preferably corresponds to the outer surface of the battery pack housing specified hereinabove. The interface, in particular the interface housing, is preferably arranged at least partially, preferably at least substantially completely, on the first surface.

It is also proposed that at least one part of the wall facing the mounting direction of the interface be arranged in the area of the second surface. Advantageously, damage to the interface and/or the battery pack housing, particularly in a transition area between the interface and the battery pack housing, preferably when connecting to and/or disconnecting from the consumer, can be easily and/or effectively counteracted by design. Voltage peaks can advantageously be reduced at particularly critical points. The wall is preferably arranged at least substantially completely on one side of the interface facing the mounting direction. The mounting direction preferably extends at least substantially parallel to the at least one guide rail, in particular a main extension axis of the at least one guide rail. The expression “main extension axis” of an object is in particular understood to mean an axis which extends parallel to a longest edge of a smallest geometrical cuboid which just completely encloses the object, and in particular extends through the center of the cuboid. The first surface and/or the second surface extend(s) in particular at least substantially parallel to the mounting direction. The mounting direction corresponds in particular to a direction of movement of the consumer relative to the battery pack, in particular the battery pack device when the consumer is mounted on the battery pack, preferably the battery pack device, preferably the interface. In particular, when the consumer is removed from the battery pack device, preferably from the battery pack, the consumer is moved relative to the battery pack device, in particular to the battery pack, in the opposite direction to the mounting direction. A main extension axis of the wall preferably extends at least substantially perpendicular to the mounting direction. In particular, the main extension axis of the wall extends at least substantially perpendicular to the at least one guide rail, preferably the main extension axis of the at least one guide rail.

It is further proposed that the area of the second surface be arranged at least on one side of the interface, in particular facing the mounting direction of the interface specified hereinabove. Advantageously, damage to the interface and/or the battery pack housing, in particular in a transition area between the interface and the battery pack housing, preferably when connecting to and/or disconnecting from the consumer, can be counteracted in a simple, effective and/or space-saving manner. Voltage peaks at particularly critical points can advantageously be reduced in order to save space. In particular, the first surface is arranged downstream of the second surface in a direction parallel to the mounting direction.

It is further proposed that the interface comprises at least one guide rail, in particular the guide rail specified hereinabove, and at least one flexible unit which is arranged at least partially on the guide rail. A particularly robust battery pack device can be provided in an advantageous manner. Damage to the battery pack housing, the interface and/or the consumer caused by impacts or the like can be counteracted simply and/or particularly effectively. A particularly durable and/or reliable battery pack device can be provided. In particular, the flexible unit is designed to absorb shocks to the consumer and/or the battery pack device, preferably the interface and/or the battery pack housing. The flexible unit can, e.g., comprise one flexible, in particular elastic, element or a plurality of flexible, in particular elastic, elements.

It is also proposed that the flexible unit comprises at least one flexible, preferably elastic, element, in particular flexible element specified hereinabove, which is arranged on a side of the guide rail facing the battery pack housing. A particularly reliable fixing of the battery pack device to the consumer can be achieved in an advantageous manner. A particularly gentle and at the same time precise fixing of the battery pack device to the consumer can be achieved. A particularly durable battery pack device can be achieved in an advantageous manner. The flexible element is preferably arranged on a surface of the guide rail opposite the battery pack housing. Preferably, the flexible element is arranged between the guide rail and the battery pack housing. The flexible element is preferably arranged at a distance from the battery pack housing.

The flexible element is preferably attached to the guide rail. The flexible element can be deflected, preferably elastically, in particular in the direction of the guide rail, preferably to absorb impacts on the guide rail. It is conceivable that the flexible element is designed to be integral with the guide rail, or that the flexible element is detachably, in particular non-destructively detachable, attached to the guide rail. The elastic element is, e.g., attached at two points or, alternatively, at just one point on the guide rail. It is conceivable that, e.g., the flexible element is attached to the guide rail by overmolding, crimping, hot caulking or the like. The flexible element is preferably in contact with the consumer, in particular with the battery pack interface of the consumer, in a state of the interface arranged on the consumer. Preferably, the flexible element is pre-tensioned in a state of the consumer arranged on the battery pack device. Pretensioning of the flexible element can be generated in particular by connecting the consumer to the interface. Alternatively or additionally, it is also conceivable that the flexible unit comprises at least one flexible, preferably elastic, element, in particular the one specified hereinabove, which is arranged on a side of the guide rail facing away from the battery pack housing. Furthermore, it is alternatively or additionally conceivable that the flexible unit comprises at least one flexible, preferably elastic, element, in particular the one specified hereinabove, which is arranged, preferably attached, to the battery pack housing, preferably on the interface side.

It is further proposed that the flexible element is designed as a leaf spring. Advantageously, a particularly reliable and/or precise fixing of the consumer to the battery pack device, in particular at the interface, can be achieved at low cost. The elastic element is preferably designed as a stamped-bent part. The elastic element can, e.g., be made of metal, plastic or the like. Alternatively, it is also conceivable that the flexible element is designed as a rubber-elastic element, e.g. as a rubber plate, a rubber cube or the like, as a coil spring, a torsion spring, or the like.

It is further proposed that the flexible unit comprises at least one flexible, preferably elastic, element, in particular the element specified hereinabove, which is arranged between two mounting ribs of the guide rail extending at least substantially parallel to one another. A particularly space-saving, flexible unit can be provided. Advantageously, a compact and at the same time particularly robust and/or durable battery pack device can be provided. In particular, the mounting ribs each comprise a guide surface along which the consumer can be guided during mounting on and/or removal from the battery pack device, preferably the interface. The mounting ribs are preferably arranged on opposite sides of the guide rail. A mounting rib of the mounting ribs is arranged in particular on a side of the guide rail facing the battery pack housing. A further mounting rib of the mounting ribs is arranged in particular on a side of the guide rail facing away from the battery pack housing. The additional mounting rib is preferably designed to be sturdier than the mounting rib. It is alternatively conceivable that the mounting rib and the further mounting rib have the same thickness, or that the mounting rib is designed to be sturdier than the further mounting rib. The mounting ribs preferably extend at least substantially parallel to each other. The mounting ribs preferably extend at least substantially parallel to the mounting direction and/or to the main extension axis of the guide rail. It is alternatively conceivable that the mounting ribs extend at an angle to each other. Alternatively, it is also conceivable that the mounting ribs, in particular the mounting rib and/or the further mounting rib, extend at an angle to the mounting direction and/or to the main extension axis of the guide rail. The flexible element preferably extends over at least a part of a maximum longitudinal extension of the guide rail, in particular over at least 25%, preferably over at least 50% of the maximum longitudinal extension and preferably over at least substantially the entire maximum longitudinal extension of the guide rail, in particular over at least 75% and particularly preferably over at least 90% of the maximum longitudinal extension of the guide rail.

It is further proposed that the at least one guide rail comprises a receiving chamber for a flexible, in particular elastic, element, in particular the flexible element specified hereinabove, the receiving chamber being completely closed or open on one side in the mounted state. A particularly space-saving, flexible unit can be provided in an advantageous manner. A compact and at the same time particularly robust and/or durable battery pack device can be provided in an advantageous manner. The flexible element is designed, in particular in at least one exemplary embodiment, as a flexible layered element. The flexible element is, e.g., designed to be plate-shaped. An object being “at least essentially plate-shaped,” is in particular understood to mean that at least one smallest possible geometric cuboid, which just completely encloses the object, is plate-shaped. An object being “plate-shaped” is in particular understood to mean a spatial object which, when viewed in a development in a plane, comprises a non-circular cross-sectional area in a cross-section perpendicular to the plane and, perpendicular to the plane, features an at least substantially constant material thickness which is less than 50%, preferably less than 25% and particularly preferably less than 10% of a surface extension of the spatial element parallel to the plane, in particular of a smallest surface extension of the element parallel to the plane.

Alternatively, however, it is also conceivable that the flexible element has a different shape, in particular a shape other than an at least essentially plate-shaped shape, e.g. tubular, beam-shaped, prism-shaped, or the like. Preferably, the flexible element fills the receiving chamber at least substantially completely. It is conceivable that the flexible element is clamped and/or glued in the receiving chamber. It is also conceivable that the flexible element is at least partially or at least substantially completely encapsulated by the interface housing. The interface housing, in particular the guide rail, is preferably made, in particular at least partially, preferably at least substantially completely, of a hard plastic, e.g. of a glass fiber-filled thermoplastic, in particular a polyamide with glass fiber filling, a polycarbonate, a copolymer, a mixture of a polycarbonate and an acrylonitrile-butadiene-styrene copolymer, or the like. The flexible element particularly preferably features a hardness that is lower than the hardness of the guide rail. The flexible element preferably features a flexibility that is higher than the flexibility of the guide rail. The flexible element preferably features a Shore A measured value of greater than 60 and preferably less than 90. Alternatively, however, it is also conceivable that the Shore A measured value is less than 60 or greater than 90. The flexible element particularly preferably features an elasticity that is higher than the elasticity of the guide rail. The elongation at break of the flexible element is preferably at least 100%. The receiving chamber preferably extends over at least part of a maximum longitudinal extension of the guide rail, in particular over at least 25%, preferably over at least 50% of the maximum longitudinal extension and preferably over at least substantially the entire maximum longitudinal extension of the guide rail, in particular over at least 75% and particularly preferably over at least 90% of the maximum longitudinal extension of the guide rail. The receiving chamber is in particular arranged between the mounting rib and the further mounting rib. It is also conceivable that the at least one guide rail comprises a plurality of receiving chambers for one flexible, in particular elastic, element each. It is also conceivable that a plurality of flexible, in particular elastic, elements can be arranged in the receiving chamber.

It is further proposed that the flexible, in particular elastic, element is designed as an elastomer filling, whereby the elastomer filling is in particular made of entropy-plastic material. Advantageously, the flexible unit can be manufactured particularly easily and/or cost-effectively.

Further proposed is a battery pack, in particular one comprising the battery pack device specified hereinabove. A particularly robust and/or durable battery pack can be provided as an advantage.

The disclosure is further based on a method for producing a battery pack device, in particular the battery pack device specified hereinabove, having a battery pack housing, in particular the battery pack housing specified hereinabove, and having at least one interface, in particular the interface specified hereinabove, for an electrical and mechanical connection to a consumer, in particular the consumer specified hereinabove, whereby the interface comprises at least one contact support, in particular the contact support specified hereinabove, which is arranged adjacent to a wall, in particular the wall specified hereinabove, of the battery pack device. It is proposed that the wall is designed to be at least partially curved. By designing the method in this way, a particularly high level of robustness can be achieved for the battery pack device. A particularly durable and stable battery pack device can be provided. A particularly high level of safety can be achieved in an advantageous manner. A particularly high product quality can be achieved in an advantageous manner. This embodiment of the battery pack device makes it possible to reduce voltage peaks and/or improve the flow of force. Advantageously, tearing of the battery pack device and/or the interface caused by voltage peaks can be counteracted particularly easily and/or effectively.

The battery pack device, the battery pack, and/or the method are not intended be limited to the application and embodiment described hereinabove. In particular, the battery pack device, the battery pack, and/or the method for fulfilling a function described herein can comprise a number of individual elements, components, and units, as well as method steps that differs from a number specified herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the following description of the drawings. Four exemplary embodiments of the disclosure are shown in the drawings. The drawings, the description, and the claims contain numerous features in combination. A skilled person will appropriately also consider the features individually and combine them into additional advantageous combinations.

Shown are:

FIG. 1 a battery pack comprising a battery pack device in a schematic representation,

FIG. 2 a schematic sequence of a method for manufacturing the battery pack device,

FIG. 3 a battery pack comprising a battery pack device in a first alternative embodiment in a schematic representation,

FIG. 4 a battery pack comprising a battery pack device in a second alternative embodiment in a cross-sectional view,

FIG. 5 the battery pack device from FIG. 4 in connection with a consumer in a cross-sectional view and

FIG. 6 a battery pack comprising a battery pack device in a third alternative embodiment of a schematic representation.

### DETAILED DESCRIPTION

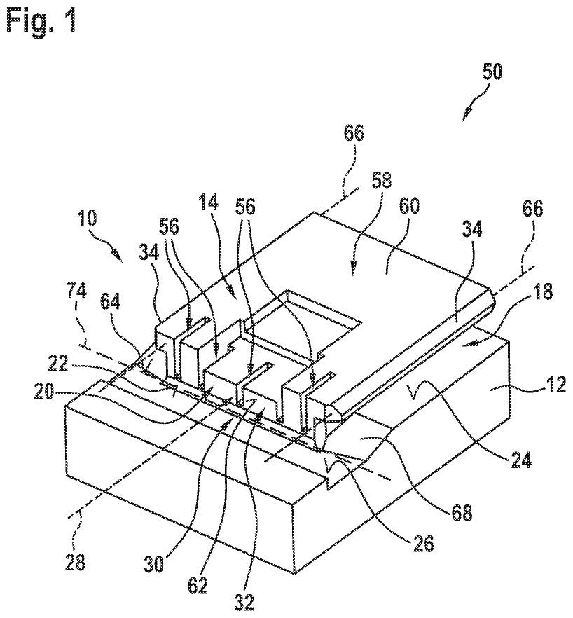

FIG. 1 shows a battery pack 50 comprising a battery pack device 10. In this example, the battery pack 50 is designed as a hand-held power tool rechargeable battery pack. The battery pack device 10 comprises a battery pack housing 12. The battery pack device 10 comprises at least one interface 14 for an electrical and mechanical connection to a consumer. In particular, the interface 14 is designed to be at least partially integral with the battery pack housing 12.

The interface 14 is arranged on an interface side 18 of the battery pack housing 12. The interface 14 comprises at least one contact support 20. The contact support 20 comprises a plurality of electrical contact elements 56. It is alternative conceivable that the contact support 20 only comprises an electrical contact element 56. The battery pack 50, in particular the battery pack device 10, comprises a battery cell unit (not shown in this case). The battery cell unit comprises a battery cell or a plurality of battery cells, in particular interconnected battery cells. The electrical contact elements 56 are designed as contact plugs. It is alternative conceivable that at least some of the electrical contact elements 56 are designed as contact plates or the like. The electrical contact elements 56 are provided to establish an electrical connection between the battery cell unit and the consumer, in particular a battery pack interface of the consumer.

The consumer is preferably designed as a hand-held power tool, e.g. as a drilling machine, as a screwing machine, as a sawing machine, as a grinding machine or as another hand-held power tool that appears advantageous to a skilled person. It is alternatively conceivable that the consumer is designed as a household appliance, e.g. as a kitchen appliance, as a cleaning appliance, in particular as a vacuum cleaner, as a radio, as a light, or as another electrical appliance that appears advantageous to a skilled person.

The interface 14 comprises a mechanical connection unit 58 for a mechanical connection of the battery pack 50, in particular the battery pack device 10, to the consumer. By means of the mechanical connection unit 58, the battery pack device 10 can be attached to the consumer, preferably detachably, particularly preferably non-destructively. The mechanical connection unit 58 comprises two guide rails 34. The consumer can be guided along the guide rails 34 for mounting and/or removing the consumer on/from the battery pack 50, in particular the battery pack device 10. The guide rails 34 are provided as holding rails for the consumer. The interface side 14 faces the consumer when the battery pack 50, preferably the battery pack device 10, is arranged on the consumer.

The contact support 20 is arranged adjacent to a wall 22 of the battery pack device 10. The wall 22 is designed to be integral with at least one part of the battery pack housing 12. The wall 22 is designed to be integral with at least part of the interface 14. The wall 22 is arranged between the interface 14, in particular the contact support 20, and the battery pack housing 12. The wall 22 connects the battery pack housing 12 to the interface 14, in particular to the contact support 20, in particular at least in a partial area of the battery pack device 10.

The wall 22 is designed to be curved. The wall 22 has a constant curvature. It is alternatively conceivable that the wall 22 has a varying curvature. The wall 22 defines a circular arc with a center angle of between 0° and 180°, preferably 90°.

The interface 14 comprises an interface housing 60. The interface housing 60 is designed to be at least partially integral with the battery pack housing 12 and/or the wall 22. The wall 22 adjoins an outer surface 62 of the interface 14, preferably the interface housing 60. The wall 20 adjoins an outer surface 64 of the battery pack housing 12. The outer surface 64 of the battery pack housing 12 extends at an angle to the outer surface 62 of the interface housing 60. In particular, the outer surface 64 of the battery pack housing 12 extends at least substantially perpendicular to the outer surface 64 of the interface 14, preferably the interface housing 60.

The battery pack housing 12 comprises a first surface 24 on the interface side 18 and a second surface 26 that is recessed relative to the first surface 24. The wall 22 is arranged at least partially in an area 30 of the second surface 26. The wall 22 is arranged at least substantially completely in the area 30 of the second surface 26, at least when viewed in a direction perpendicular to the second surface 26. The wall 22 is arranged on the second surface 26. The first surface 24 is arranged on the interface side 18. The second surface 26 is arranged on the interface side 18. The first surface 24 extends at least substantially parallel to the second surface 26. Alternatively, however, it is also conceivable that the first surface 24 extends at an angle to the second surface 26.

A value of a maximum height of the wall 22 corresponds to a value of a minimum distance of the first surface 24 from the second surface 26, in particular at least when viewed in a direction perpendicular to the first surface 24 and/or second surface 26. It is alternatively conceivable that a value of the maximum height of the wall 22 is smaller or greater than a value of the minimum distance between the first surface 24 and the second surface 26, in particular at least when viewed in the direction perpendicular to the first surface 24 and/or second surface 26. The second surface 26 is recessed relative to the first surface 24 with respect to the interface 14. The first surface 24 and the second surface 26 each define a plane, whereby the wall 22 is arranged completely between the planes. It is alternatively conceivable that the wall 22 is arranged at least partially between the planes defined by the first surface 24 and the second surface 26. The second surface 26 corresponds to the outer surface 64 specified hereinabove of the battery pack housing 12. The interface 14, in particular the interface housing 60, is arranged at least partially, preferably at least substantially completely, on the first surface 24.

At least a part of the wall 22 facing a mounting direction 28 of the interface 14 is arranged in the area 30 of the second surface 26. The wall 22 is arranged at least substantially completely on a side of the interface 14 facing the mounting direction 28. The mounting direction 28 extends at least substantially parallel to the guide rails 34, in particular the respective main extension axes 66 of the guide rails 34. The first surface 24 and/or the second surface 26 extend at least substantially parallel to the mounting direction 28. The mounting direction 28 corresponds to a direction of movement of the consumer relative to the battery pack 50, in particular the battery pack device 10, when the consumer is mounted on the battery pack 50, preferably the battery pack device 10, in particular the interface 14.

A main extension axis 74 of the wall 22 extends at least substantially perpendicular to the mounting direction 28. The main extension axis 74 of the wall 22 extends at least substantially perpendicular to the guide rails 34, preferably the main extension axes 66 of the guide rails 34.

The area 30 of the second surface 26 is arranged at least on a side 32 of the interface 14 facing the mounting direction 28 of the interface 14. The first surface 24 is arranged downstream of the second surface 26 as viewed in a direction parallel to the mounting direction 28.

A further surface 68 is arranged between the first surface 24 and the second surface 26. The further surface 68 connects the first surface 24 to the second surface, in particular at least on the interface side 18. The further surface 68 connects the first surface 24 to the second surface 26 in a ramp-like manner. The other surface 68 lies at an angle to the first surface 24. The other surface 68 lies at an angle to the second surface 26. The other surface 68 lies at an angle different from 90° to the first surface 24. The other surface 68 lies at an angle different from 90° to the second surface 26. The further surface 68 is arranged at least substantially completely between the planes defined by the first surface 24 and the second surface 26.

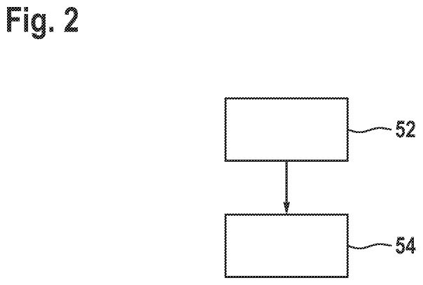

FIG. 2 shows a schematic sequence of a method for manufacturing the battery pack device 10. In a method step 52, the production materials are provided in a raw form. In a method step, in particular in a manufacturing step 54, the wall 22 is designed to be curved.

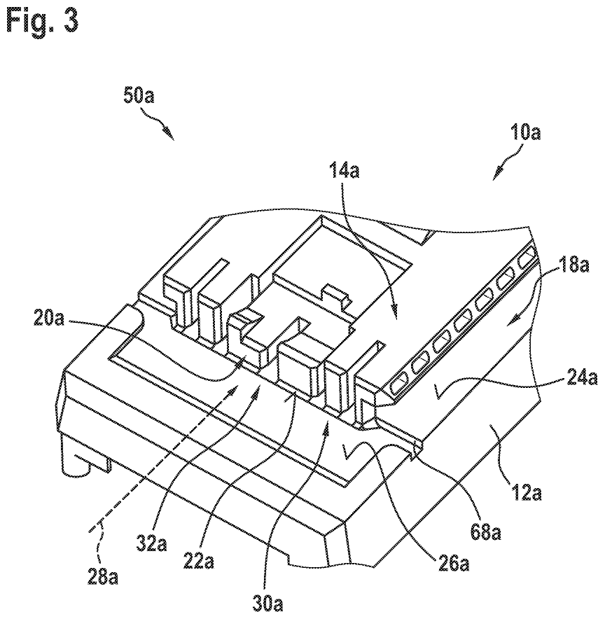

FIGS. 3 to 6 show further exemplary embodiments of the disclosure. The following descriptions and the drawings are essentially limited to the differences between the exemplary embodiments, whereby with regard to components with the same designation, in particular with regard to components having the same reference numbers, reference can in principle also be made to the drawings and/or the description of the other exemplary embodiments, in particular of FIGS. 1 and 2. To differentiate between the embodiments, the reference characters of the embodiment in FIGS. 1 and 2 are not followed by a letter and the embodiments in FIGS. 3 to 6 are followed by the letters a to c.

FIG. 3 shows a battery pack 50a comprising a battery pack device 10a. The battery pack device 10a comprises a battery pack housing 12a. The battery pack device 10a comprises at least one interface 14a for an electrical and mechanical connection to a consumer. The interface 14a is arranged on an interface side 18a of the battery pack housing 12a. The interface 14a comprises at least one contact support 20a. The contact support 20a is arranged adjacent to a wall 22a of the battery pack device 10a. The wall 22a is designed to be curved. The battery pack housing 12a comprises a first surface 24a on the interface side 18a and a second surface 26a that is recessed relative to the first surface 24a. The wall 22a is arranged at least partially in an area 30a of the second surface 26a.

A further surface 68a is arranged between the first surface 24a and the second surface 26a. The further surface 68a connects the first surface 24a to the second surface 26a, in particular at least on the interface side 18a. The further surface 68a connects the first surface 24a to the second surface 26a in a ramp-like manner. The other surface 68a lies at an angle to the first surface 24a. The other surface 68a lies at an angle to the second surface 26a. The further surface 68a extends at least substantially perpendicular to the first surface 24a. The further surface 68a extends at least substantially perpendicular to the second surface 26a. The further surface 68a is arranged at least substantially completely between the planes defined by the first surface 24a and the second surface 26a.

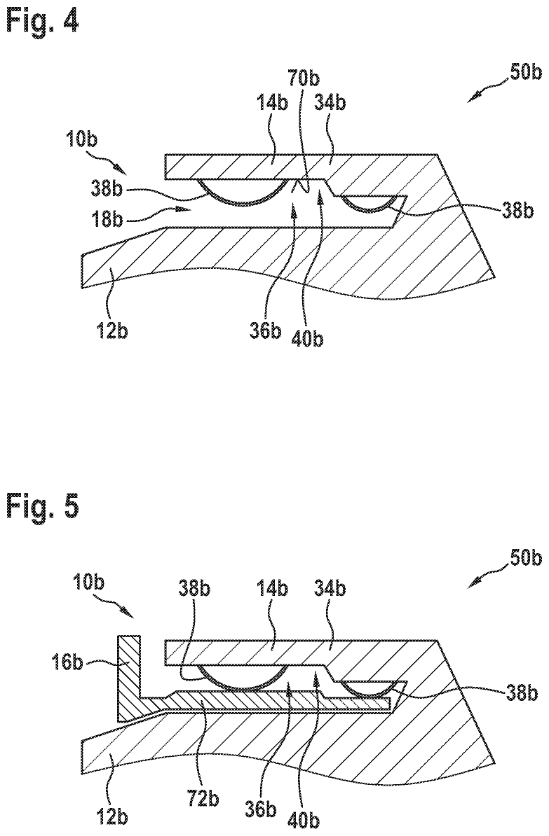

FIGS. 4 and 5 show a battery pack 50b comprising a battery pack device 10b. The battery pack device 10b comprises a battery pack housing 12b. The battery pack device 10b comprises at least one interface 14b for an electrical and mechanical connection to a consumer 16b. The interface 14b is arranged on an interface side 18b of the battery pack housing 12b.

The interface 14b comprises two guide rails 34b (only one of the two guide rails 34b is shown in FIGS. 4 and 5). The interface 14b comprises at least one flexible unit 36b. The flexible unit 36b is arranged at least partially on the guide rails 34b. The flexible unit 36b is provided to absorb shocks to the consumer and/or the battery pack device 10b, preferably the interface 14b and/or the battery pack housing 12b.

The flexible unit 36b comprises a plurality of flexible, preferably elastic, elements 38b (only two of the plurality of flexible elements 38b are shown in FIGS. 4 and 5). The flexible elements 38b are arranged on a side 40b of the guide rails 34b facing the battery pack housing 12b. It is alternatively conceivable that the flexible unit 36b comprises only one flexible element 38b.

The flexible elements 38b are arranged on a surface 70b of the guide rails 34b opposite the battery pack housing 12b. The flexible elements 38b are arranged between the respective guide rail 34b and the battery pack housing 12b. The flexible elements 38b are arranged at a distance from the battery pack housing 12b. The flexible elements 38b are each attached to one of the guide rails 34b. The flexible elements 38b can be deflected, preferably elastically, in the direction of the respective guide rail 34b, preferably in order to cushion impacts on the respective guide rail 34b. It is conceivable that the flexible elements 38b are designed to be integral with the respective guide rail 34b, or that the flexible elements 38b are detachably, in particular non-destructively detachable, attached to the respective guide rail 34b. It is conceivable, e.g., that the flexible elements 38b are attached to the respective guide rail 34b by overmolding, crimping, hot caulking or the like. In a state of the interface 14b arranged at the consumer, the flexible elements 34b are in contact with the consumer 16b, in particular with a battery pack interface 72b of the consumer 16b. The flexible elements 38b are pretensioned in a state of the consumer 16b arranged on the battery pack device 10b. A pretension of the flexible elements 38b can be generated in particular by connecting the consumer 16b to the interface 14b.

Alternatively or additionally, it is also conceivable that the flexible unit 36b comprises at least one flexible, preferably elastic, element 38b, which is arranged on a side facing away from the battery pack housing 12b on at least one of the guide rails 34b. Furthermore, it is alternatively or additionally conceivable that the flexible unit 38b comprises at least one flexible, preferably elastic, element 38b, which is arranged, preferably fixed, on the battery pack housing 12b, preferably on the interface side 18b.

The flexible elements 38b are designed as leaf springs. The flexible elements 38b are designed as stamped-bent parts. The flexible elements 38b can be made of at least one metal, a plastic or the like. Alternatively, it is also conceivable that at least some of the flexible elements 38b are designed as rubber-elastic elements, e.g. as a rubber plate, as a rubber cube or the like, as a helical spring, as a torsion spring or the like.

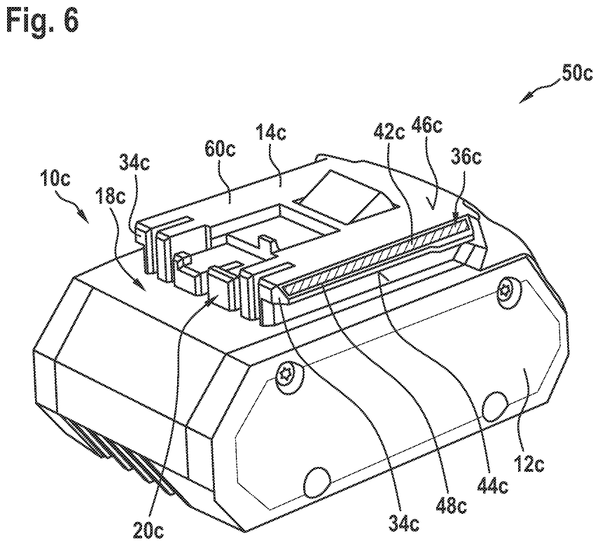

FIG. 6 shows a battery pack 50c comprising a battery pack device 10c. The battery pack device 10c comprises a battery pack housing 12c. The battery pack device 10c comprises at least one interface 14c for an electrical and mechanical connection to a consumer. The interface 14c is arranged on an interface side 18c of the battery pack housing 12c.

The interface 14c comprises two guide rails 34c. The interface 14c comprises at least one flexible unit 36c. The flexible unit 36c is arranged on the guide rails 34c. The flexible unit 36c comprises two flexible, preferably elastic, elements 42c (only one of the two flexible elements 42c is shown in FIG. 6). It is alternatively conceivable that the flexible unit 36c comprises only one flexible element 42c or more than two flexible elements 42c. The flexible elements 42c are each arranged between two mounting ribs 44c, 46c of the guide rail 34c which extend at least substantially parallel to one another (in FIG. 6, only the mounting ribs 44c, 46c of one of the two guide rails 34c are provided with reference numerals).

The mounting ribs 44c, 46c each comprise guide surfaces along which the consumer can be guided during mounting on and/or removal from the battery pack device 10c. The mounting ribs 44c, 46c are arranged on opposite sides of the respective guide rail 34c. A mounting rib 44c of the mounting ribs 44c, 46c is arranged on a side of the respective guide rail 34c facing the battery pack housing 12c. A further mounting rib 46c of the mounting ribs 44c, 46c is arranged on a side of the respective guide rail 34c facing away from the battery pack housing 12c. The further mounting rib 46c is designed to be sturdier than the mounting rib 44c. It is alternatively conceivable that the mounting rib 44c and the further mounting rib 46c have the same thickness, or that the mounting rib 44c is designed to be sturdier than the further mounting rib 46c.

The mounting ribs 44c, 46c extend at least substantially parallel to each other. The mounting ribs 44c, 46c extend at least substantially parallel to a mounting direction and/or to main extension axes of the guide rails 34c. It is alternatively conceivable that the mounting ribs 44c, 46c extend at an angle to each other. Alternatively, it is also conceivable that the mounting ribs 44c, 46c extend at an angle to the mounting direction and/or to the main extension axes of the guide rails 34c.

The flexible elements 42c each extend over at least part of a maximum longitudinal extent of the respective guide rail 34c, in particular over at least 25%, preferably over at least 50% of the maximum longitudinal extent and preferably over at least substantially the entire maximum longitudinal extent of the respective guide rail 34c, in particular over at least 75% and particularly preferably over at least 90% of the maximum longitudinal extent of the respective guide rail 34c.

The guide rails 34c each comprise a receiving chamber 48c for one of the flexible elements 42c (only one of the receiving chambers 48c is shown in FIG. 6). The receiving chambers 48c are designed to be open on one side when mounted. The receiving chambers 48c each extend over at least part of a maximum longitudinal extent of the respective guide rail 34c, in particular over at least 25%, preferably over at least 50% of the maximum longitudinal extent and preferably over at least substantially the entire maximum longitudinal extent of the respective guide rail 34c, in particular over at least 75% and particularly preferably over at least 90% of the maximum longitudinal extent of the respective guide rail 34c. The receiving chambers 48c are arranged between the mounting rib 44c and the further mounting rib 46c of the respective guide rail 34c. It is also conceivable that the guide rails 34c comprise a plurality of receiving chambers 48c, each for a flexible, in particular elastic, element 42c. It is also conceivable that a plurality of flexible, in particular elastic, elements 42c can be arranged in each of the receiving chambers 48c.

The flexible elements 42c are designed as flexible layer elements. The flexible elements 42c are each designed as an elastomer filling. The elastomer filling is made of entropy-plastic material in particular. The flexible elements 42c are designed to be at least substantially plate-shaped. Alternatively, however, it is also conceivable that the flexible elements 42c have a different shape, in particular a shape other than an at least substantially plate-shaped shape, e.g. tubular, beam-shaped, prism-shaped, or the like. The flexible elements 42c at least substantially completely fill the respective receiving chamber 48c. It is conceivable that the flexible elements 42c are clamped and/or glued in the respective receiving chamber 48c. An interface housing 60c of the interface 14c, in particular the guide rails 34c, are made, in particular at least partially, preferably at least substantially completely, of a hard plastic. The flexible elements 42c feature a hardness that is lower than a hardness of the guide rails 34c. The flexible elements feature a flexibility that is higher than the flexibility of the guide rails 34c. The flexible elements 34c feature an elasticity that is higher than the elasticity of the guide rails 34c.

It is alternatively conceivable that the receiving chambers 48c are designed to be completely closed in the assembled state. It is alternatively conceivable that the flexible elements 42c are at least partially or at least substantially completely overmolded by the interface housing 60c of the interface 14c.

What is claimed is:

1. A battery pack device, comprising:
at least one battery pack housing having an interface side; and
at least one interface configured for an electrical and mechanical connection to a consumer,
wherein the at least one interface is arranged on the interface side of the at least one battery pack housing,
wherein the at least one interface includes at least one contact support which is arranged adjacent to a wall of the battery pack device, and
wherein the wall is designed to be curved.

2. The battery pack device according to claim 1, wherein:
the at least one battery pack housing includes a first surface on the interface side and a second surface which is recessed relative to the first surface, and
the wall is arranged at least partially in an area of the second surface.

3. The battery pack device according to claim 2, wherein at least a part of the wall facing a mounting direction of the at least one interface is arranged in the area of the second surface.

4. The battery pack device according to claim 2, wherein the area of the second surface is arranged on at least one side of the at least one interface facing a mounting direction of the interface.

5. The battery pack device according to claim 1, wherein the at least one interface includes at least one guide rail and at least one flexible unit which is arranged at least partially on the at least one guide rail.

6. The battery pack device according to claim 5, wherein the at least one flexible unit includes at least one flexible element which is arranged on a side of the at least one guide rail facing the at least one battery pack housing.

7. The battery pack device according to claim 6, wherein the at least one flexible element is designed as a leaf spring.

8. The battery pack device according to claim 5, wherein:
the at least one guide rail includes two mounting ribs that extend at least substantially parallel to one another, and
the at least one flexible unit includes at least one flexible element which is arranged between the two mounting ribs.

9. The battery pack device according to claim 5, wherein:
the at least one guide rail includes a receiving chamber for a flexible element, and
the receiving chamber is designed to be completely closed or open on one side in the assembled state.

10. The battery pack device according to claim 9, wherein:
the flexible element is designed as an elastomer filling, and
the elastomer filling is made of entropy-plastic material.

11. A battery pack comprising a battery pack device according to claim 1.

12. A method for producing a battery pack device according to claim 1, the batter back device, comprising:
a battery pack housing; and
at least one interface configured for an electrical and mechanical connection to a consumer,
wherein the at least one interface includes at least one contact support which is arranged adjacent to a wall of the battery pack device, and
wherein the wall is designed to be curved.

13. The battery pack device according to claim 6, wherein the at least one flexible element is designed to be elastic.

14. The battery pack device according to claim 8, wherein the at least one flexible element is designed to be elastic.

15. The battery pack device according to claim 9, wherein the flexible element is designed to be elastic.
